(19) United States
(12) Patent Application Publication
(10) Pub. No.: US 2017/0160929 A1
(43) Pub. Date: Jun. 8, 2017

(54) IN-ORDER EXECUTION OF COMMANDS RECEIVED VIA A NETWORKING FABRIC

(71) Applicant: HEWLETT PACKARD ENTERPRISE DEVELOPMENT LP, Houston, TX (US)

(72) Inventor: Siamack Ayandeh, Littleton, MA (US)

(21) Appl. No.: 14/957,276

(22) Filed: Dec. 2, 2015

(51) Int. Cl. G06F 3/06

(52) U.S. Cl. CPC G06F 3/061; G06F 3/0688; G06F 3/0659

(57) ABSTRACT

Example implementations relate to reception and reordering of commands received over a networking fabric. For example, a command may be received over a networking fabric. A determination can be made whether the command indicates a requirement for in-order execution. If the command indicates the requirement, the command can be delivered for in-order execution. If the command does not indicate the requirement, the command can be delivered in an order in which the command is received over the networking fabric.

### BACKGROUND

Datacenters and cloud storage arrays often use high-performance, low-latency non-volatile memory (NVM) for storage. Such storage can be accessed over a networking fabric. Storage arrays may receive tens of thousands of individual queues of instructions over a networking fabric. These instructions received over the networking fabric may be received out of order or not received at all. Logic within storage appliances of such datacenters may reorder received instructions to ensure proper execution.

### BRIEF DESCRIPTION OF THE DRAWINGS

FIG. 1A is a block diagram illustrating an example networked storage system in which the described examples may be implemented.

FIG. 1B is a layer diagram illustrating the example storage system of FIG. 1A.

FIG. 2 illustrates an example method for delivering commands, according to the present examples.

FIG. 3 illustrates an example method for selectively indicating a requirement for in-order execution, according to the present examples.

FIG. 4 illustrates an example computing device upon which embodiments described herein may be implemented.

### DETAILED DESCRIPTION

Examples such as described enable selective reordering of commands received over a networking fabric. According to an example, a computing device operates to receive a command over the networking fabric, and to determine whether the command indicates a requirement for in-order execution. If the command indicates the requirement, the command can be delivered for in-order execution. If the command does not indicate the requirement, the command can be delivered for execution in an order in which the command is received over the networking fabric.

In other variations, examples are implemented using instructions that are stored with a non-transitory computer-readable storage medium that is executable by a processor to cause the processor to perform an example method as described.

In another example, a computing device may receive a plurality of commands that are communicated over a networking fabric, and for each of the plurality of commands, make a determination whether the command requires in-order execution. The commands may be selectively delivered for in-order execution based on the determination.

In another example, a host device may determine whether or not a command for transmission over a networking fabric requires in-order execution. In the command requires in-order execution, the host device may generate a command structure indicating the requirement. If the command does not require in-order execution, a command structure may be generated not indicating the requirement. The command structure may then be transmitted to a storage array over the networking fabric.

Aspects described herein provide that methods, techniques and actions performed by a computing device are performed programmatically, or as a computer-implemented method. Programmatically means through the use of code, or computer-executable instructions. A programmatically performed step may or may not be automatic.

Examples described herein can be implemented using engines, which may be any combination of hardware and programming to implement the functionalities of the engines. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In such examples, the at least one machine-readable storage medium may store instructions that, when executed by the at least one processing resource, implement the engines. In examples, a system may include the machine-readable storage medium storing the instructions and the processing resource to execute the instructions, or the machine-readable storage medium may be separate but accessible to the system and the processing resource.

Furthermore, aspects described herein may be implemented through the use of instructions that are executable by a processor or combination of processors. These instructions may be carried on a non-transitory computer-readable medium. Computer systems shown or described with figures below provide examples of processing resources and computer-readable mediums on which instructions for implementing some aspects can be carried and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, aspects may be implemented in the form of computer programs.

As discussed above, instructions received over a networking fabric may sometimes be received out of order or not received at all. Such instructions may be reordered to ensure proper in-order execution. For example, received commands may be buffered until a delayed command arrives. However, the ordering logic required for such reordering is complex, and may be costly, particularly given the use of tens of thousands of queues in modern storage arrays. To counter this complexity and cost, rather than providing ordering logic for every queue of received instructions, some storage arrays aggregate queues, adjusting the granularity of data streams requiring in-order delivery. For example, other approaches have provided granularity on a per-fabric port basis, or on a per-controller basis, rather than per-queue. While such aggregation may decrease the complexity and cost of such approaches, additional problems may arise. For example, a lost or delayed command can hold up all streams sharing the same ordering logic (e.g., if granularity is provided on a per-fabric-port basis, a lost or delayed command can hold up all streams sharing the same fabric port). Such delays can be called head-of-line blocking. Additionally, other approaches either provide for in-order execution of all commands at a given granularity, or they do not provide for command re-ordering at all. In other words, other approaches cannot selectively provide in-order execution. This may be problematic, because often only a small proportion of commands may require in-order execution.

Examples as described recognize the shortcomings of conventional approaches with respect to head-of-line blocking and lack of selectivity for ordering logic in storage arrays. Examples as described may provide low cost, selective in-order execution of commands received over a networking fabric.

Examples as described provide for selective in-order delivery of commands for execution. Commands received over the networking fabric may include an indication that the command requires in-order execution. Commands including this indication may be delivered for in-order execution. Commands lacking such an indication may be delivered in the order in which they are received over the networking fabric. Providing support for such indications may allow efficient and low-cost operations, as the expense and complexity of associated with in-order execution may be employed only for commands requiring in-order execution. For example, the demand on ordering logic may be reduced, which may allow for better granularity to be achieved (i.e., fewer received commands require in-order execution, so fewer received commands require use of the ordering logic). Additionally, providing support for selective in-order execution may allow better performance for applications transmitting such commands (e.g., delays may be avoided or reduced because often only a small proportion of an application's transmitted commands require in-order execution).

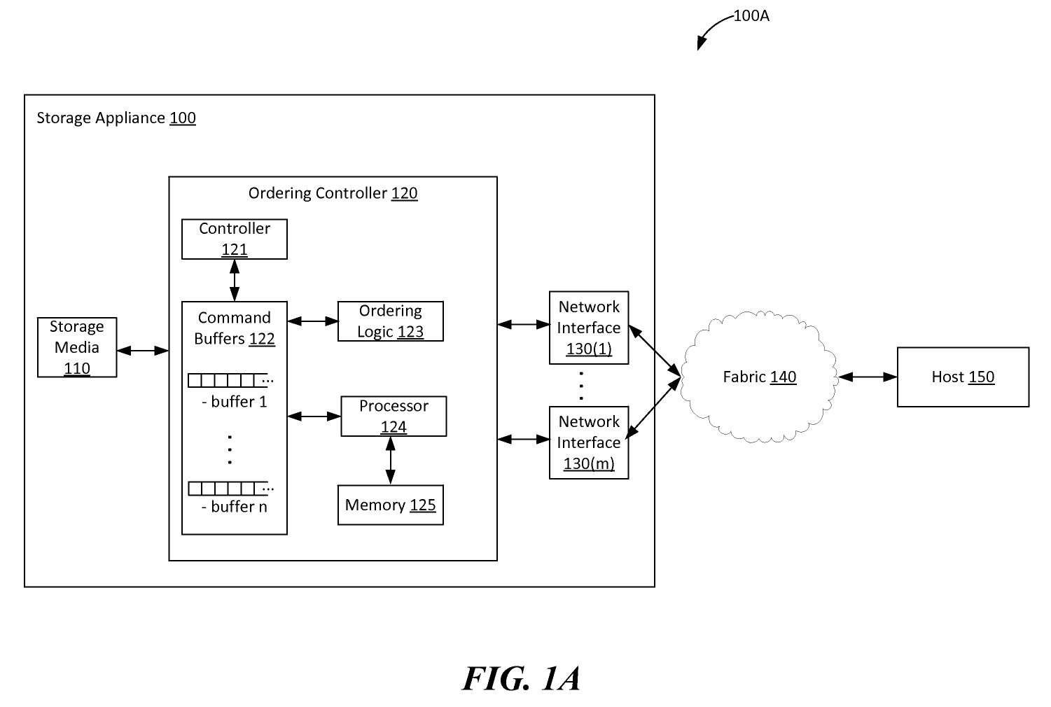

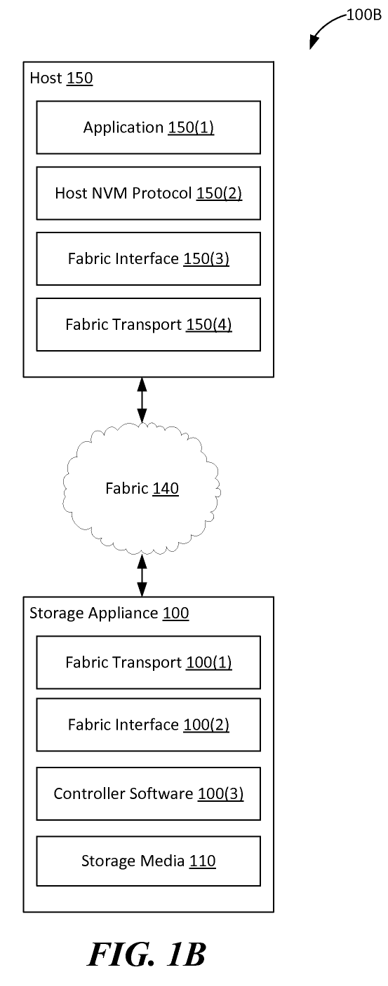

FIG. 1A illustrates an example networked storage system 100A, in which the described examples can be implemented. As shown in FIG. 1, system 100A may include a storage appliance 100, a networking fabric 140, and a host device 150. Storage appliance 100 may include storage media 110, which may be coupled to an ordering controller 120, and network interfaces 130(1)-130(m). Ordering controller 120 may include a controller 121, coupled to command buffers 122, comprising n buffers. Command buffers 122 may also be coupled to ordering logic 123, processor 124, and memory 125.

With respect to FIG. 1A, network interfaces 130(1)-130(n) may receive, via networking fabric 140, commands transmitted by host device 150. Host device 150 may be any suitable computing device capable of communicating over networking fabric 140. Fabric 140 may be a suitable network of switching equipment comprising multiple nodes interconnected using network switches. Commands may be received by network interface 130(1)-130(m) may be received via fabric ports. In some examples, each network interface 130(x) may have a corresponding fabric port, while in other examples a single network interface may include multiple fabric ports. Received commands may be sent to ordering controller 120. Ordering controller 120 may determine whether a received command is out of order (e.g., processor 124 may execute ordering logic 123 to make this determination). If a command is determined to be out of order, it may be buffered in one of buffer 1-buffer n. Each buffer may correspond to one or more queues for received commands. The command may then be delivered for execution in an appropriate specified order. The command may be a command which accesses storage media 110. For example, the command may read from stored data in storage media 110, or may write to stored media 110.

FIG. 1B shows a layer diagram 100B, showing software layers of system 100A, in which the described embodiments can be implemented. A host device 150 may include an application layer 150(1), a host NVM protocol layer 150(2), a fabric interface layer 150(3), and a fabric transport layer 150(4). As shown in FIG. 1A, host 150 may be coupled to storage appliance 100 via fabric 140. Storage appliance 100 may include a fabric transport layer 100(1), a fabric interface layer 100(2), a controller software layer 100(3), and storage media 110. With respect to FIG. 1B, an application may run in application layer 150(1) of host device 150. This application may generate a service call to host NVM protocol 150(2). For example, the application may request to read or write a unit of data. The NVM protocol 150(2) may generate a command entry for a queue based on the service call. This command entry can contain information about the location of the data, associated pointers, and the data itself (if the command is a write command). Fabric interface layer 150(3) may encapsulate this command entry into a capsule. This capsule may include control information such as a controller identifier and a queue identifier where the encapsulated command entry should be sent. This capsule may be further encapsulated by fabric transport layer 150(4) into an information unit (IU). The IU may contain fabric-specific information. The IU may then be included in one or more frames. For example, the IU may be included in a single frame, or may be fragmented into multiple frames. Each frame includes a header and a data portion. The header may include information such as a source address (i.e., the host address) a destination storage array address (e.g., an address of storage appliance 100), as well as other related fields. The one or more frames may then be transmitted via fabric 140 to storage appliance 100.

Further with respect to FIG. 1B, the one or more frames may be received by storage appliance 100 via fabric 140. Fabric transport layer 100(1) may recover the transmitted IU and the capsule. Fabric interface 100(2) may then recover the command entry from the capsule, and the command entry may be stored in a queue controlled by controller software 100(3). After execution by the controller (e.g., ordering controller 120 if FIG. 1A), a response may be returned to application 150(1).

As described above, conventional approaches to providing in-order execution of commands received over a networking fabric provide in-order execution on an “all-or-nothing” basis—all commands are processed for in-order execution, or none are. For example, a command entry, such as generated by host NVM protocol 150(2) of host device 150 of FIG. 1B, may be assigned a command sequence number (CSN), indicating an order of the command. Subsequent commands may have subsequent CSNs. For example, a sequence of commands may be transmitted from a host device having an order {CSN₁, CSN₂, CSN₃, . . . }. However, the same sequence of commands may be received by a storage appliance (e.g., storage appliance 100 of FIG. 1A), having an order {CSN₁, CSN₃, CSN₂, . . . }. Logic, such as ordering logic 123 of storage appliance 100 of FIG. 1A, may ensure that the commands are executed in proper order. For example, the command having CSN₁ is received first, and is first in order, so it may be delivered for execution. However, the command having CSN₃ is received second, but should be delivered third. This command may be buffered (e.g., in command buffers 122 of FIG. 1A). When the command having CSN₂ is received, it may be delivered for execution, and then the command having CSN₃ may be delivered from the buffer for execution. Note that while CSNs are described in this example as starting from one, in other examples the first CSN in a queue may begin from other predetermined values. For example, the host device and the storage appliance may operate according to a protocol which specifies the first CSN, the storage appliance may specify the first CSN, or the host device may indicate the first CSN.

More generally, because such ordering logic can be expensive as tens of thousands of queues may be used in a storage appliance, correspondingly large buffers may be required to ensure restoration of potential out of order commands. An expected maximum out of order count may determine an appropriate size for each buffer (e.g., each of command buffers 122 of FIG. 1A). For example, a maximum out of order count of k corresponds to receiving a command k CSNs out of order—for example, when a command having CSN₁ is followed by a command having CSNₖ. For an expected maximum out of order count of k, k commands should be buffered per stream to restore all expected out of order commands. Often it may be difficult to accurately determine an appropriate maximum out of order count for a given fabric and queue (e.g., due to changing network conditions and loads).

As described above, the disclosed examples provide for selective in-order delivery of commands for execution. In particular, disclosed examples allow a requirement for in-order delivery to be indicated on a per-command basis, allowing in-order execution to be maintained for commands where it is required, but providing relaxed delivery requirements for other commands. The described examples may indicate a requirement for in-order delivery by including a predetermined signal in commands transmitted to a storage appliance via a networking fabric. For example, such a predetermined signal may be a short signal, such as a one-bit signal, indicating whether or not a command requires in-order delivery. If the one-bit signal is set, then the CSN may be incremented, and if the one-bit signal is reset, the CSN may not be incremented. Alternatively, the predetermined signal may instead be a CSN which is not set to zero—in other words, a CSN of zero may indicate that in-order delivery is not required. In some examples, another predetermined CSN may indicate that in-order delivery is not required. A predetermined signal may be included in one or more of the layers of the host-fabric interface and the fabric-storage appliance interface—in other words, one or more of the layers 150(1)-150(4) and 100(1)-100(3) of FIG. 1B. A resource timeout may be used to determine when a command frame is stale, such that commands are discarded after the resource timeout.

For implementations using the short-signal (such as the one-bit signal) to indicate the in-order requirement, an example host device may transmit a series of commands as follows:

| | CSN | | | | | | |
|---|---|---|---|---|---|---|---|
| | CSN₁ | CSN₂ | CSN₂ | CSN₂ | . . . | CSN₂ | CSN₃ |
| in-order | 1 | 1 | 0 | 0 | . . . | 0 | 1 |

where in-order=1 indicates the in-order requirement, and in-order=0 indicates no in-order requirement. The commands may be received over a networking fabric by a storage appliance in the following order:

CSN

| | CSN₃ | CSN₂ | CSN₂ | . . . | CSN₂ | CSN₁ |
|---|---|---|---|---|---|---|
| in-order | 1 | 1 | 0 | . . . | 0 | 1 |

The commands may be received, and the in-order requirement indicators may be recognized. The first two commands may be buffered, as they are out of order, and include the in-order requirement indicator. The remaining commands having CSN₂ but no in-order requirement may be delivered for execution in the order in which they arrive—in other words, these commands may be delivered for execution in the order in which they were received from the networking fabric. Once CSN₁ arrives, then the commands corresponding to CSN₁, CSN₂, and CSN₃ may be delivered in order for execution.

For implementations where a nonzero CSN indicates the in-order requirement, a similar example may be described. For example, a host device may transmit a series of commands as follows:

| | | | | | | | |
|---|---|---|---|---|---|---|---|
| CSN | CSN₁ | CSN₂ | 0 | 0 | . . . | 0 | CSN₃ |

where CSN≠0 indicates the in-order requirement, and CSN=0 indicates no in-order requirement. The commands may be received over a networking fabric by a storage appliance in the following order:

| | | | | | | | |
|---|---|---|---|---|---|---|---|
| CSN | CSN₃ | 0 | CSN₂ | 0 | . . . | 0 | CSN₁ |

The commands may be received, and the in-order requirement indicators may be recognized. The commands corresponding to CSN₃ and CSN₂ may be buffered, as they are out of order, and indicate the in-order requirement. Commands having CSN=0 may be delivered for execution in the order in which they are received from the networking fiber. When the command having CSN₁ is received, then the commands corresponding to CSN₁, CSN₂, and CSN₃ may be delivered in order for execution.

As described above, the in-order requirement may be indicated in one or more of the layers of example host-fabric interfaces and fabric-storage appliances. In some examples such indications may be used to improve performance or to reduce the number of commands received out of order. For example, preferential treatment could be provided to commands indicating the in-order requirement, or to commands indicating the in-order requirement and having a sufficiently low CSN. In particular, the in-order requirement may be indicated by an application (e.g., in application layer 150(1) of FIG. 1B) as a Boolean variable indicating whether an associated service call requires in-order delivery. The in-order requirement may also be indicated by in a command entry generated by a host NVM protocol (e.g., host NVM protocol 150(2) of FIG. 1B). For example, a bit in a command entry data structure may be set to indicate an in-order requirement, and reset to indicate a lack of the in-order requirement. In some examples, an NVM protocol may indicate the in-order requirement based on detecting the in-order requirement indicated by a service call. In some other examples, the NVM protocol can determine that the service call requires in-order delivery based on a command type associated with the service call. The in-order requirement may also be indicated in a capsule generated by a fabric interface layer (e.g., fabric interface layer 150(3) of FIG. 1B). The fabric interface layer may indicate the in-order requirement based on detecting the requirement indicated by the command entry. The in-order requirement may also be indicated in an Information Unit (IU) generated by a fabric transport layer (e.g., fabric transport layer 150(4) of FIG. 1B). The in-order requirement may also be indicated in frames generated by example fabric transport layers.

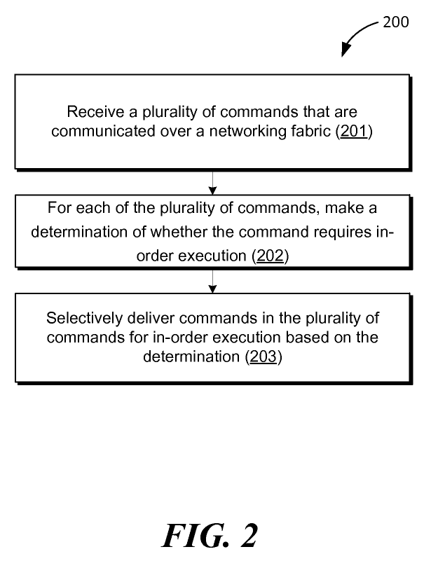

FIG. 2 illustrates an example method 200 for ordering commands, according to the present examples. The method depicted in FIG. 2 may be performed, e.g., by object management platform 100 of FIG. 1.

In accordance with some examples, a plurality of commands may be received which are communicated over a networking fabric (201). For each of the plurality of commands, a determination may be made whether the command requires in-order execution (202). In some examples, this determination may be made by detecting whether or not each received command includes a non-zero command sequence number. In some examples, this determination may be determined by ordering controller 120 of storage appliance 100 of FIG. 1A. Commands in the plurality of commands may be delivered for in-order execution based on the determination (203). In some examples, selectively delivering the commands may include delivering commands requiring in-order execution for in-order execution, and delivering commands not requiring in-order execution in an order in which the commands were received over the networking fabric.

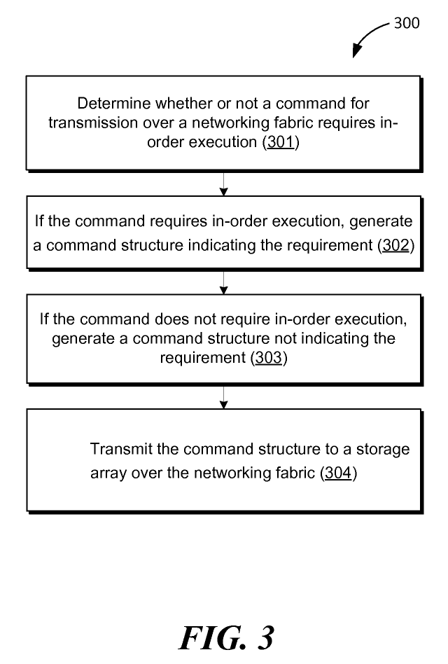

FIG. 3 illustrates an example method 300 for indicating a requirement for in-order execution of a command to be delivered over a networking fabric, according to some of the present examples. As shown in FIG. 3, example method 300 may include determining whether or not a command for transmission over the networking fabric requires in-order execution (301). If the command requires in-order execution, a command structure may be generated indicating the requirement (302). In some examples, generating the command structure may include generating a command entry corresponding to the command, encapsulating the command entry using a fabric interface layer of the host device, generating an information unit including the encapsulated command entry using a fabric transport layer of the host device, and generating one or more frames corresponding to the information unit. In some examples, indicating the requirement may include setting an in-order flag in the command entry. In some examples, indicating the requirement may include setting the in-order flag in the encapsulated command entry. In some examples, indicating the requirement may include setting the in-order flag in the information unit. In some examples, indicating the requirement may include setting the in-order flag in the one or more frames. If the command does not require in-order execution, a command structure may be generated which does not indicate the requirement (303). The command structure may then be transmitted to a storage array via the networking fabric (304).

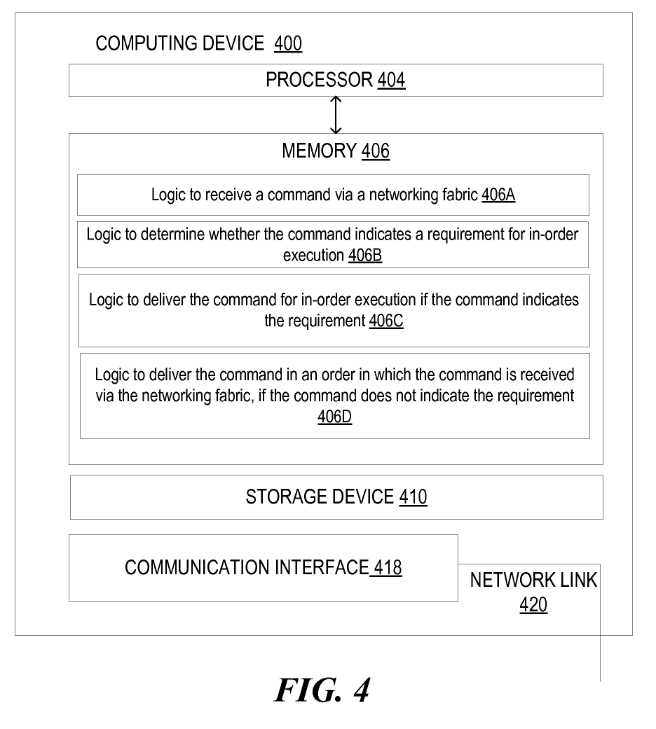

FIG. 4 is a block diagram that illustrates an example computing device 400 for selectively reordering received commands, according to embodiments described herein. For example, in the context of FIG. 1A and FIG. 1B, storage appliance 100 may be implemented using a computing such as described by FIG. 4.

In an embodiment, computing device 400 includes processor 404, memory 406 (including non-transitory memory), storage device 410, and communication interface 418. Computing device 400 includes at least one processor 404 for processing information. Computing device 400 also includes the memory 406, such as a random access memory (RAM) or other dynamic storage device, for storing information and instructions to be executed by processor 404. For example, memory 406 can store (i) logic to receive a command via a networking fabric 406A, (ii) logic to determine whether the command indicates a requirement for in-order execution 406B, (iii) logic to deliver the command for in-order execution if the command indicates the requirement 406C, and (iv) logic to deliver the command in an order in which the command is received via the networking fabric, if the command does not indicate the requirement 406D, in accordance with some aspects. In some examples, the method 200 of FIG. 2, or the storage appliance 100 of FIG. 1 may be implemented using the logic stored in memory 406. Memory 406 also may be used for storing temporary variables or other intermediate information during execution of instructions to be executed by processor 404. Computing device 400 may also include a read only memory (ROM) or other static storage device for storing static information and instructions for processor 404. The storage device 410, such as a magnetic disk or optical disk, is provided for storing information and instructions. The communication interface 418 may enable the computing device 400 to communicate with a network (e.g., receiving commands via a networking fabric, as in FIG. 1) through use of the network link 420 and any one of a number of well-known transfer protocols (e.g., Fibre Channel Protocol (FC), or Ethernet). Examples of networks include a local area network (LAN), a wide area network (WAN), the Internet, mobile telephone networks, Plain Old Telephone Service (POTS) networks, and wireless data networks (e.g., Wi-Fi and WiMAX networks).

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other aspects. Thus, absence of describing combinations should not preclude the inventor(s) from claiming rights to such combinations.

What is claimed is:

1. A non-transitory computer-readable storage medium that stores a set of instructions, which when executed by a processor of a computing device, cause the computing device to:
receive a command via a networking fabric;
make a determination whether the command indicates a requirement for in-order execution;
if the command indicates the requirement, deliver the command for in-order execution; and
if the command does not indicate the requirement, deliver the command in an order in which the command is received via the networking fabric.

2. The non-transitory computer-readable storage medium of claim 1, wherein the instructions which execute to make the determination further cause the computing device to determine whether the command includes an in-order indicator.

3. The non-transitory computer-readable storage medium of claim 2, wherein the in-order indicator is a nonzero command sequence number.

4. The non-transitory computer-readable storage medium of claim 2, wherein the in-order indicator is a one-bit signal indicating that in-order execution is required;
wherein execution of the instructions further cause the computing device to:
increment a command sequence number if the command indicates the requirement; and
not increment the command sequence number if the command does not indicate the requirement.

5. The non-transitory computer-readable storage medium of claim 1, wherein the instructions which execute to deliver the command for in-order execution further cause the computing device to process the command using an ordering logic.

6. The non-transitory computer-readable storage medium of claim 1, wherein execution of the instructions further cause the computing device to:
receive a plurality of commands that are communicated over the networking fabric;
for each of the plurality of commands, make a determination of whether the command requires in-order execution before delivering the command for execution; and
selectively deliver commands in the plurality of commands for in-order execution based on the determination.

7. A method for delivering commands, the method being implemented by a processor and comprising:
receiving a plurality of commands that are communicated over a networking fabric;
for each of the plurality of commands, making a determination of whether the command requires in-order execution; and
selectively delivering commands in the plurality of commands for in-order execution based on the determination.

8. The method of claim 7, wherein selectively delivering commands includes:
delivering each command requiring in-order execution for in-order execution; and
delivering each command not requiring in-order execution in an order in which the command is received via the networking fabric.

9. The method of claim 7, wherein making the determination includes detecting whether or not each command includes a nonzero command sequence number.

10. A method for selectively indicating a requirement for in-order execution of a command to be transmitted via a networking fabric, the method performed by a host device and comprising:
determining whether a command requires in-order execution;
if the command requires in-order execution, generate a command structure indicating the requirement;
if the command does not require in-order execution, generate a command structure not indicating the requirement; and
transmitting the command structure to a storage array via the networking fabric.

11. The method of claim 10, wherein generating the command structure indicating the requirement includes:
generating a command entry corresponding to the command;
encapsulating the command entry using a fabric interface layer of the host device;
generating an information unit including the encapsulated command entry using a fabric transport layer of the host device; and
generating one or more frames corresponding to the information unit.

12. The method of claim 11, wherein indicating the requirement for in-order execution includes setting an in-order flag in the command entry.

13. The method of claim 11, wherein indicating the requirement for in-order execution includes setting an in-order flag in the encapsulated command entry.

14. The method of claim 11, wherein indicating the requirement for in-order execution includes setting an in-order flag in the information unit.

15. The method of claim 11, wherein indicating the requirement for in-order execution includes setting an in-order flag in the one or more frames.
